(19) United States
(12) Patent Application Publication
(10) Pub. No.: US 2001/0034245 A1
(43) Pub. Date: Oct. 25, 2001

(54) Portable telephone interface for a laptop computer

(76) Inventor: Allen I. Swartz, North Falmouth, MA (US)

Correspondence Address: John C. Smith, 4800 North Federal Highway, Suite A-207, Boca Raton, FL, 33431, US

(21) Appl. No.: 09/773,324

(22) Filed: Jan. 31, 2001

Related U.S. Application Data
(60) Provisional application No. 60/179,566, filed on Feb. 1, 2000.

(51) Int. Cl. H04M 1/00

(52) U.S. Cl. 455/557; 455/222

(57) ABSTRACT

A local communication system in which a modem in a portable computer communicates wirelessly with the base station in a conventional portable telephone which is attached to a telephone land line. The computer may attach to the handset of a portable telephone via a jumper cable connection that is provided in the handset. Alternatively, the computer modem uses a wireless transceiver to communicate with a matching transceiver in the portable telephone base station. In another alternative configuration, the modem in the computer has an integral modem/transceiver that is used to directly communicate with the portable telephone base station. In addition to portable computers, the phone interface can be used by any communications device to communicate with a portable telephone. Alternative land lines such as coaxial cable networks or fiber-optic networks can be used in place of conventional telephone land lines.

### CROSS-REFERENCE TO RELATED APPLICATIONS

This application is a non-provisional continuation application of the commonly owned copending application entitled “Portable Phone Interface for a Laptop Computer”, filed Feb. 1, 2000, bearing U.S. Ser. No. 60/179,566 and naming Allen I. Swartz, the named inventor herein, as inventor, the contents of which is specifically incorporated by reference herein in its entirety.

### BACKGROUND OF THE INVENTION

1. Technical Field

The present invention relates to computer communications equipment. In particular, it relates to a system and method for improving the mobility and convenience of computer users by providing an interface that connects a conventional portable telephone to a laptop or portable computer which in turn allows the computer to communicate with remote computer networks without requiring the computer to be hardwired to a telephone wall socket which may be a conventional telephone land line, a coaxial cable, a fiber-optic cable, or any other suitable data communications line.

2. Background Art

The prior art has provided a variety of communication devices for interconnecting remotely located computers to one another. Initially, computers tended to be large systems that had fixed locations. These computers used hardwired communications systems which are directly attached to the telephone land lines. Due to their fixed nature, hardwiring the telephone connections did not create any inconvenience for the users.

As the computer arts developed, computers were continuously reduced in size to the point where they could now be transported as portable computers or laptop computers. In fact, they are now available as handheld devices such as PDAs (Personal Digital Assistants). All of these devices, even the hand held units, have the capability of communicating with other computers via telephone networking. Unfortunately, the freedom and convenience provided by the new portability of computers has resulted in the creation of some problems that did not apply to the larger fixed location computers.

One significant problem has been the difficulties encountered by computer users when they attempt to attach their portable computer to a telephone line in order to communicate with another computer. In particular, the user may wish to move about and take advantage of the portable nature of the computer. Unfortunately, the user is typically constrained by the need to have the computer's modem hardwired to a telephone wall socket. It would be advantageous to have a system that allows a computer user the ability to take full advantage of the mobility provided by these small portable computers.

In response to this problem, the prior art has developed cellular modems that can be inserted into a portable computer. These cellular based modems allow the computer to be used in a convenient and mobile fashion. Unfortunately, this technology, while providing one solution to the hardwiring problem of earlier systems, is not readily usable by most computer users. Specifically, the cost associated with this technology is prohibitive for many computer users. Not only is the initial cost of cellular modems substantially higher than the cost of a conventional modem (typically 3 to 5 times greater), the cost of service is an even greater obstacle to its widespread use. A cellular telephone call is usually the most expensive way to communicate with telephone systems. For example, while most land line telephone systems can be accessed for a fixed monthly fee, many cellular phone companies charge substantial per minute fees to access their system.

The cost per minute is a substantial obstacle to using cellular technology for computer communications. In today's environment, where individuals spend hours using network systems such as the Internet, the cost of using cellular modems would effectively preclude access to the Internet or other systems. It would be desirable to have a portable computer with the convenience of wireless communication, but which also does not have the expense of cellular networks.

While addressing the basic desirability of communications between remote computers, the prior art has failed to provide a system that allows users of portable computers and like devices, such as PDAs, to access currently available networks with the convenience of wireless communication, but without the prohibitive costs associated with conventional cellular networks.

### SUMMARY OF THE INVENTION

The present invention solves the foregoing problems by providing a system that allows a modem in a portable computer to communicate wirelessly with the base station in a conventional portable telephone that is in turn attached to a fixed communications network, such as a telephone land line, a coaxial cable network, a fiber optic network, or any other suitable hardwired communications network. In one embodiment, the computer is attaches to the handset of a portable telephone via a cable connection provided in the handset. In another embodiment, the modem in the computer is attached to a wireless transceiver that communicates with a matching transceiver in the portable telephone base station. In another embodiment, the modem in the computer has an integral modem/transceiver that is used to directly communicate with the portable telephone base station. In yet another embodiment, the modem in the computer is attached to a wireless transceiver which communicates with a remote transceiver that is attached to a fixed communications network which can include a telephone land line, a coaxial cable network, a fiber optic network, or any other suitable hardwired communications network.

### BRIEF DESCRIPTION OF THE DRAWINGS

FIG. 1 is a diagram that illustrates a portable telephone with a base station in which the handset is connected to the modem in a portable computer.

FIG. 2 is a diagram that illustrates a portable telephone with a base station in which the handset includes a wireless transceiver and the modem in a portable computer is also attached to a wireless transceiver. The two transceivers provide a communications path between the modem and the handset.

FIG. 3 is a diagram that illustrates a portable telephone with a base station in which the base station includes a wireless transceiver and the modem in a portable computer is also attached to a wireless transceiver. The two transceivers provide a communications path between the modem and the base station.

FIG. 4 is a diagram that illustrates a portable telephone with a base station in which the base station includes a wireless transceiver and the modem in a portable computer has an integral wireless transceiver. The two transceivers provide a communications path between the modem and the base station.

FIG. 5 illustrates a perspective view of a handset with an optional wall switch mounted on the side of the handset.

FIG. 6 illustrates another alternative embodiment in which an acoustic coupler is used to establish the communications link between a conventional telephone handset and a communications device such as a portable computer.

FIG. 7 illustrates yet another alternative embodiment in which the modem in a portable computer is attached to a transceiver that communicates with a remote transceiver that is directly attached to a fixed communications network.

### DESCRIPTION OF THE PREFERRED EMBODIMENT

Prior to a detailed discussion of the figures, a general overview of the system will be presented. The invention is designed to allow a user of a portable computer, which is not hardwired to a telephone line, to easily communicate with a computer network, such as the Internet or any other network, using low cost land lines rather than the much more expensive cellular communications paths of the prior art.

For ease of discussion, the fixed communications network to which the telephone base station is attached is discussed as though it was a conventional land line telephone network. However, throughout this discussion, when the fixed communications network is discussed in terms of a land line telephone network, it will be understood that the term land line can be used to describe any fixed network including conventional telephone land line networks, coaxial cable networks, fiber-optic networks, private branch exchanges (PBXs), satellite networks, etc.

Likewise, for ease of discussion the term “portable computer” will be used throughout the discussed an intelligent device which communicates with a land line. However, as used herein, the term portable computer includes not only conventional laptop or portable computers but also other intelligent devices such as PDAs (i.e. personal digital assistants), docking stations for use with computers, telemetry stations, etc. It would even be possible to implement the features and advantages of this invention in conjunction with intelligent cellular telephones. In particular, cellular telephones have been developed which are capable of accessing global computer networks such as the Internet. This invention will allow a cellular telephone user, when the user has access to a land line, to access remote networks such as the Internet using the land line rather than the more expensive cellular toll system.

A portable telephone is used to interface between the telephone land line and the modem in the portable computer. One method of achieving this is to run a short jumper cable from the modem to the handset of the portable computer. The handset has a conventional RJ-11 jack to plug the jumper cable into it, and a circuit to allow the signals from the modem to be input via the RJ-11 jack and transmitted from the handset to the telephone base station. Once the telephone base station receives the modem data from the handset, it transmits the data across the land line to complete the communication with the remote computer. In this manner, bidirectional communications between the computer and the telephone can be easily achieved.

Those skilled in the art will recognize that the jumper cable between the modem and the handset can be replaced by alternative non-technologies, such as infrared (IR), fiber optic cable, etc.

Another embodiment allows a small transceiver to be attached to the input/output (I/O) port of the modem and an associated transceiver to be attached to the telephone handset. This permits the handset to be placed in any convenient location such that it would not need to be very near the computer. For example, the transceiver range can be designed to allow the user to communicate with the telephone base station at any suitable distance provided it remained in the range of the transceiver. This allows the user to move about with a portable computer without having the burden of being physically connected to the telephone handset.

In another preferred embodiment, the transceiver is moved from the handset to the base station such that the computer modem would communicate wirelessly with the portable telephone base station. This provides an additional advantage in that when the wireless transceiver is embedded within the base station, the computer modem communicates directly with the base station, thereby eliminating the need to have a second transmission from the handset to the base station. Since each time data is re-transmitted, there is a possibility of injecting an error due to the transmission process, the direct transmission of data from the computer modem to the telephone base station is less prone to transmission errors.

Another embodiment replaces the modem/transceiver combination with a single device that integrates the modem function and the transceiver function in the portable computer. Of course, this modem/transceiver combination would still have to communicate with a second transceiver in the telephone handset, in the telephone base station, or attached to nontraditional land lines such as coaxial cable or fiber optic cable, etc.

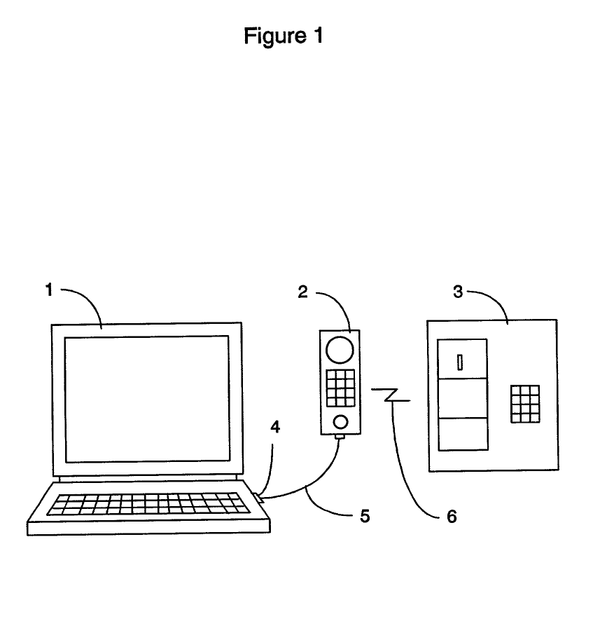

Turning to FIG. 1, this figure illustrates a preferred embodiment of the invention in which a conventional portable computer 1 with a modem 4 is attached via a telephone jumper cable 5 to a portable handset 2. The handset 2 also communicates with the portable telephone base station 3 in the conventional manner. The use of the jumper cable 5 allows the portable computer 1 to be used in any convenient location and eliminates the need to position it within reach of the telephone wall outlet. In addition, while it frees the user from the need to be located near a telephone land line wall outlet jack, it allows low cost land lines to be used by the modem 4 rather than the more expensive cellular telephone connections. In alternative prior art systems that provide mobility by using cellular modems, the cost of cellular connections can rise to the level where the use of a cellular modem is impractical. Further, the equipment cost for cellular modems is substantially higher than it is for a conventional modem 4.

To enable this embodiment of the invention to work, an I/O jack must be provided in the handset 2 to allow a telephone jumper cable 5 to be attached. An interface between the telephone jack to the telephone line must also be provided.

This can be accomplished as follows: The modem 4 will use the same I/O jack which it would normally use when attaching to a telephone wall outlet. The jumper cable 5 attaches to the modem 4 at one end and attaches to the telephone handset 2 at the other end. The handset 2 would then transmit data to and from the modem 4 via the jumper cable 5 and would transmit to and from the telephone base station 3 via wireless link 6 in the same manner as it does for non-computer calls. The telephone base station 3 would then move data between the telephone base station 3 and the telephone wall outlet in the conventional manner. As a result, the portable computer 1 can now be used in any convenient location without the constraints of being tethered to the telephone wall outlet, and without the expense associated with cellular modems. Further, this also allows the user to have the wireless connection described herein, and when convenient, it allows the user to have the ability of using the jumper cable 5 to connect the modem 4 directly to the telephone wall outlet or other selected cable or fiber optic land line network. This allows the invention to be implemented without any modification to the portable computer 1.

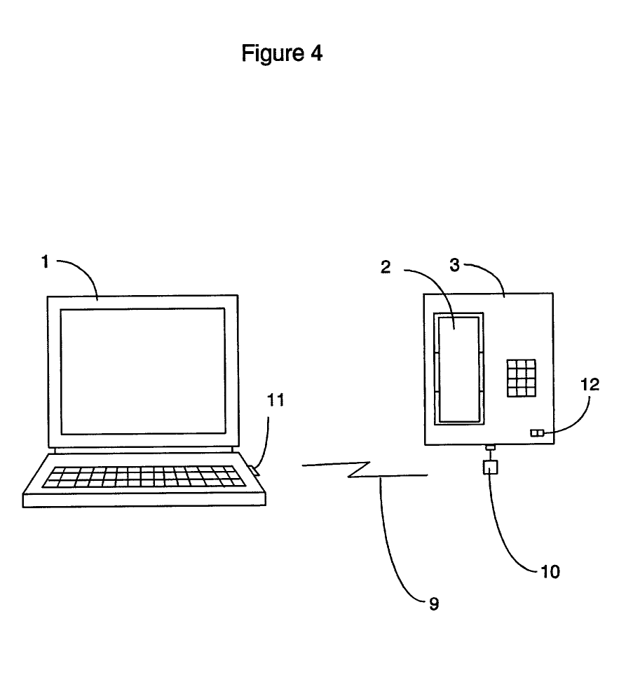

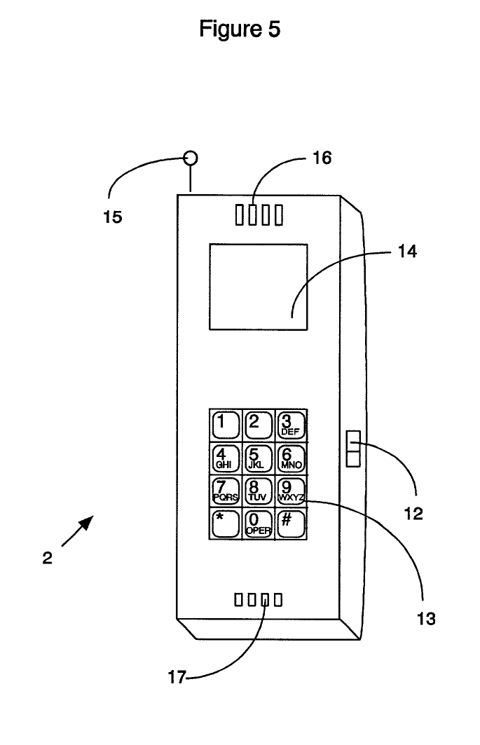

Activating the handset 2 for modem 4 communication can be accomplished in several ways. First, a simple switch 12 (shown in FIG. 5) can be added to the handset 2. By activating the switch, the handset 2 can be switched from conventional voice calls to process modem 4 data. The switch can also be mounted on the base station 3 (shown in FIG. 4) so that the telephone connection with the modem 4 can be established while the handset 2 rests in the cradle of the base station 3. Alternatively, the handset 2 can have a detection circuit to monitor the input jack. When it detects that the modem 4 is attempting to initiate a call, it can activate the handset 2 by taking it off-hook and initiating modem data transmission to the base station 3.

In the preferred embodiment of the invention, this activity would be transparent to the modem 4 which would assume that it is attached to a conventional telephone wall outlet. This can be accomplished as follows: once the handset 2 detects that the jumper cable 5 is attached, or a switch is activated, the handset 2 would present a dial tone to the modem 4.

Alternatively, control of the handset 2 and/or base station 3 can be accomplished by the computer 1 issuing commands to the handset 2 and/or base station 3 via the modem 4 and jumper cable 5.

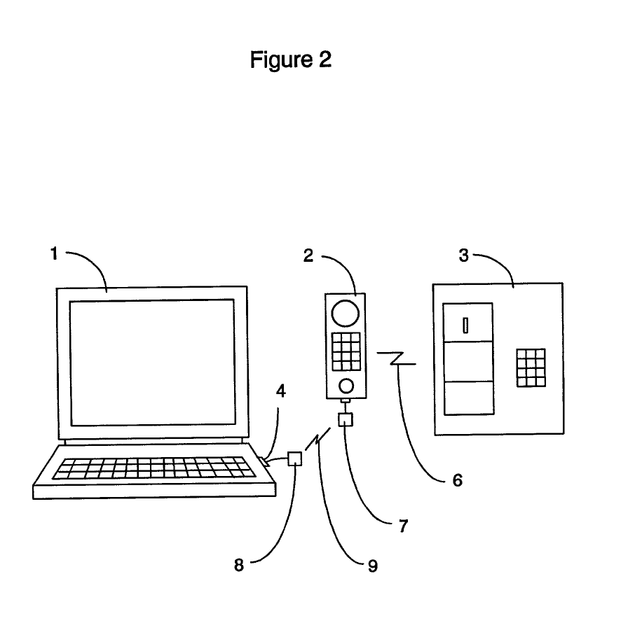

In FIG. 2, an alternative preferred embodiment is shown. In this embodiment, the telephone jumper cable 5 is eliminated and transceivers 7, 8 are used to provide wireless connection between the modem 4 and the handset 2 via wireless link 9. This allows a smaller transceiver to be attached to the computer 1 and eliminates the need to carry the handset 2 or have it near the computer 1. Activation of this link can be initiated in a manner similar to that discussed above. In particular, a manual switch on the handset 2 or the base station 3 can be activated, or the link can be activated when signals are detected by the transceivers 7, 8.

For ease of illustration, the transceivers 7, 8 are shown as separate devices. However, those skilled in the art will recognize that the transceiver 8 can be integrated into computer 1 or modem 4. Likewise, transceiver 7 can be integrated with handset 2.

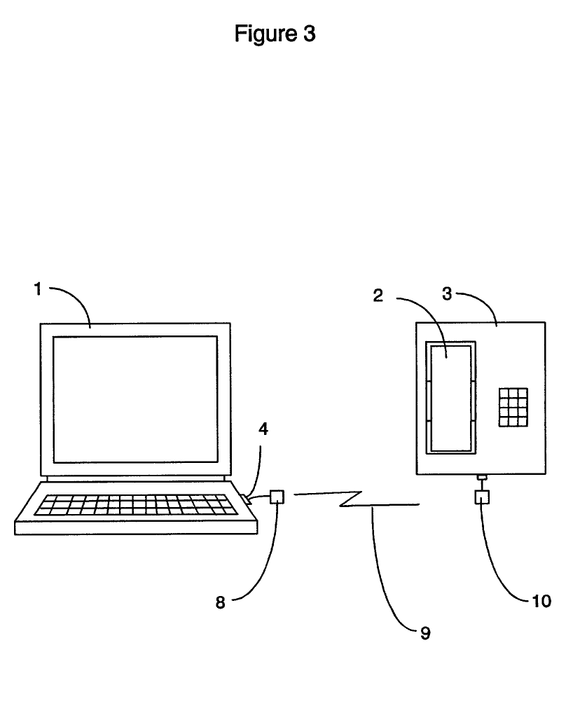

FIG. 3 illustrates another preferred embodiment. In this embodiment, the computer 1 communicates with the base station 3 directly and bypasses the handset 2. In this configuration, when the base station 3 detects that the modem 4 is attempting to communicate, it takes the telephone off-hook (or otherwise connects to the selected coaxial cable or fiber optic land line network) and initiates the call to a remote computer network.

FIG. 4 illustrates another preferred embodiment. In this embodiment, the computer 1 or the modem 4 has an integral transceiver 11 that communicates with the base station 3 directly and bypasses the handset 2. For illustrative purpose, an external transceiver 10 is shown as a separate device that is attached to the base station 3, but in practice, it would be built into the base station 3, or otherwise facilitate connection to the selected cable or fiber optic land line network.

Also shown in FIG. 4 is optional switch 12. The optional switch 12 is activated by the user and has the effect of placing the handset 2 into off-hook status even though the handset 2 remains in the cradle of the base station 3. This provides additional convenience for the user who no longer has to take a handset 2 off hook and either carry the handset 2 with him or leave it off-hook.

In FIG. 5, an alternative embodiment is shown in which the optional switch 12 is mounted on the handset 2 rather than on the base station 3. Also shown in this figure are the speaker 16, microphone 17, display 14, keyboard 13, and antenna 15 which are standard components of a portable telephone. When the user wishes to activate the communications link between the base station 3 and a portable computer 1, the activation of switch 12 will place handset 2 into off hook status even though the handset 2 may be resting in the cradle of base station 3. In the preferred embodiment, activation of switch 12 will also automatically notify the base station 3 that the handset 2 is in off hook mode.

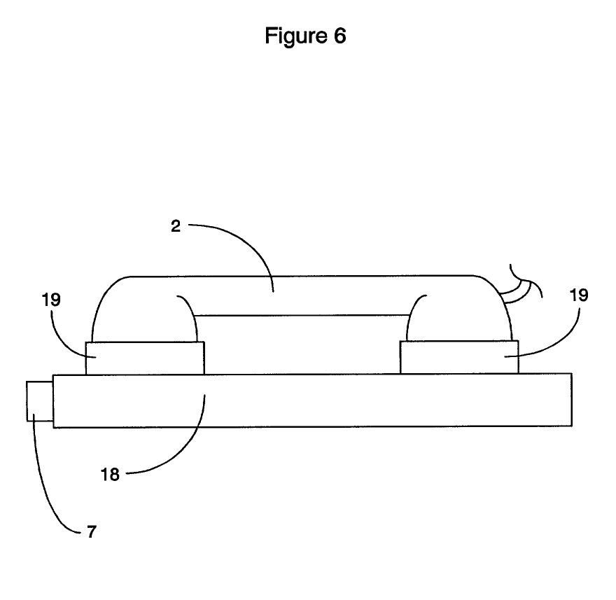

FIG. 6 illustrates another alternative embodiment in which an acoustic coupler is used to establish the communications link between a conventional telephone handset 2 and a communications device such as a portable computer 1. In this embodiment the hardwired telephone handset 2 is placed in the acoustic coupler 18. Acoustic coupler 18 has two pliant mating attachments 19 which connect directly to the telephone handset 2. Acoustic couplers are well-known in the art and are typically used with equipment for the hearing impaired etc.. In this preferred embodiment, the acoustic coupler 18 has an integral transceiver 7 which is used to provide a wireless communications link with a device such as a portable computer 1.

Those skilled in the art will recognize that the acoustic coupler 18 allows conventional telephones as well as portable telephones to be used as wireless communications links without requiring any change whatsoever to the telephone.

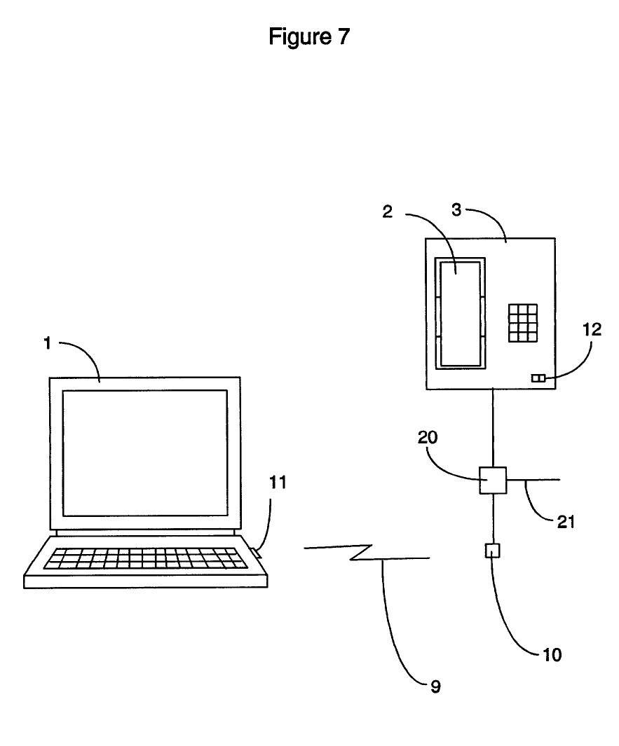

FIG. 7 illustrates another alternative preferred embodiment. In this embodiment, the portable computer 1 uses a modem with an integral transceiver 11 (or alternatively, a modem 4 with a transceiver 8 that is connected to the modem 4 via a jumper cable) to communicate with a remote transceiver 10. In this embodiment, the remote transceiver 10 is attached to land line wall outlet 20. This embodiment preferably incorporates appropriate interface circuits to communicate with the specific type of land line 21 used (i.e. telephone, coaxial cable, fiber optic cable, etc). The interfaces for each type of these land lines 21 are well-known in the art.

This figure also illustrates a conventional wireless telephone attached to the wall outlet 20. As shown in this figure, the remote transceiver 10 and the conventional wireless telephone can share the same land line 21. This allows the features and advantages of the invention to be realized without altering or replacing existing telephones.

The advantages provided by the invention allow wireless links to a portable computer modem to be made which are affordable and greatly increase the utility of portable computers. In addition, they also provide the convenience which was heretofore only available from high cost cellular modems using expensive cellular toll communication systems. Further this invention can be implemented without modifying existing modems, or requiring any changes in the architecture of existing portable computers.

While the invention has been described with respect to a preferred embodiment thereof, it will be understood by those skilled in the art that various changes in detail may be made therein without departing from the spirit, scope, and teaching of the invention. For example, the cables between the computer and the handset can be any medium suitable for a given bandwidth, the type of wireless connection can be anything suitable for the intended purpose, the type of land line technology can vary, etc. Accordingly, the invention herein disclosed is to be limited only as specified in the following claims.

I claim:

1. An apparatus for providing wireless data transmission between a modem in a portable computer and a land line, further comprising:
a wireless base station, the wireless base station further comprising:
means to attach to a land line; and
means to communicate with a wireless telephone handset;
the wireless telephone handset further comprising:
means to communicate with the wireless base station; and
means to communicate with a modem in a portable computer;
whereby a portable computer can communicate with a land line via a wireless telephone.

2. An apparatus, as in claim 1, further comprising:
a manual switch, the manual switch located on the wireless telephone handset and further having a voice position in which the wireless telephone is used for voice communications, and a data position in which the wireless telephone is used for data transmission between a computer and a telephone land line.

3. An apparatus, as in claim 1, further comprising:
a manual switch, the manual switch located on the wireless telephone base station and further having a voice position in which the wireless telephone is used for voice communications, and a data position in which the wireless telephone is used for data transmission between a computer and a telephone land line.

4. An apparatus, as in claim 1, wherein the land line is a telephone communications network.

5. An apparatus, as in claim 1, wherein the land line is a fiber-optic communications network.

6. An apparatus, as in claim 1, wherein the land line is a coaxial cable communications network.

7. An apparatus, as in claim 1, wherein the means to communicate with the modem in the portable computer further comprises:
a cable connection in the wireless telephone handset; and
a cable having a proximal end and a distal end, the proximal end of the cable having means to connect to the cable connection in the wireless telephone handset, and the distal end of the cable having means to connect to the modem of a portable computer;
whereby the cable connects the modem of the portable computer to the wireless telephone handset which communicates with the wireless telephone base station which is connected to and communicates with the land line.

8. An apparatus, as in claim 1, wherein the means to communicate with the modem in the portable computer further comprises:
a first wireless transceiver in the wireless telephone handset;
a second wireless transceiver connected to the modem of a portable computer; and
the first and second wireless transceiver having means to communicate with one another;
whereby the first and second wireless transceivers are the data communications path between modem of the portable computer and the wireless telephone handset.

9. An apparatus, as in claim 1, wherein the means to communicate with the modem in the portable computer further comprises:
a first wireless transceiver in the wireless telephone base station;
a second wireless transceiver connected to the modem of a portable computer; and
the first and second wireless transceiver having means to communicate with one another;
whereby the first and second wireless transceivers are the data communications path between modem of the portable computer and the wireless telephone base station.

10. An apparatus, as in claim 9, further comprising a manual switch, the manual switch located in the telephone handset and further having a voice position in which the wireless telephone is used for voice communications, and a data position in which the wireless telephone is used for data transmission between a computer and a telephone land line.

11. An apparatus, as in claim 9, further comprising a manual switch, the manual switch located in the wireless base station to and further having a voice position in which the wireless telephone is used for voice communications, and a data position in which the wireless telephone is used for data transmission between a computer and a telephone land line.

12. An apparatus for providing wireless data transmission between a modem in a portable computer and a telephone land line, further comprising:
a telephone, the telephone further comprising:
means to attach to a land telephone line; and
a telephone handset;
an acoustic coupler, further comprising:
means in the acoustic coupler to attach to the telephone handset such that data can be sent bidirectionally through the acoustic coupler to the telephone; and
means to communicate wirelessly with a modem in a portable computer;
whereby the portable computer can wirelessly communicate with the telephone land line via the acoustic coupler and the telephone.

13. A method of providing wireless data transmission between a modem in a portable computer and a telephone land line, including the steps of:
attaching a wireless telephone having a base station and a wireless handset to a land line; and
communicating between the wireless base station and the wireless handset;
communicating between the wireless telephone and a modem in a portable computer;
whereby a portable computer can communicate with a telephone land line via a wireless telephone.

14. A method, as in claim 13, including the additional step of attaching a manual switch to the wireless telephone handset, the manual switch having a voice position in which the wireless telephone is used for voice communications, and a data position in which the wireless telephone is used for data transmission between a computer and a telephone land line.

15. A method, as in claim 13, including the additional step of attaching a manual switch to the wireless telephone base station, the manual switch having a voice position in which the wireless telephone is used for voice communications, and a data position in which the wireless telephone is used for data transmission between a computer and a telephone land line.

16. A method, as in claim 13, including the additional step of using a telephone communications network as the land line.

17. A method, as in claim 13, including the additional step of using a fiber-optic communications network as the land line.

18. A method, as in claim 13, including the additional step of using a coaxial cable communications network as the land line.

19. A method, as in claim 13, including the additional steps of:
the means to communicate with the modem in the portable computer further comprises:
connecting a first end of a cable to the wireless telephone handset; and
connecting a second end of the cable to the modem of a portable computer;
whereby the cable connects the modem of the portable computer to the wireless telephone handset which communicates with the wireless telephone base station which is connected to and communicates with the land line.

20. A method, as in claim 13, including the additional steps of:
communicating between the modem in the portable computer and the wireless telephone by attaching a first wireless transceiver to the wireless telephone handset, and attaching a second wireless transceiver to the modem of a portable computer; and
communicating between the portable computer in the wireless telephone via the first and second wireless transceivers;
whereby the first and second wireless transceivers are the data communications path between modem of the portable computer and the wireless telephone handset.

21. A method, as in claim 13, including the additional steps of:
communicating between the modem in the portable computer and the wireless telephone by attaching a first wireless transceiver to the wireless telephone base station, and attaching a second wireless transceiver to the modem of a portable computer; and
communicating between the portable computer in the wireless telephone via the first and second wireless transceivers;
whereby the first and second wireless transceivers are the data communications path between modem of the portable computer and the wireless telephone handset.

22. A method, as in claim 21, including the additional step of using a manual switch, located in the telephone handset, to switch the wireless telephone between a voice position in which the wireless telephone is used for voice communications, and a data position in which the wireless telephone is used for data transmission between a computer and a telephone land line.

23. A method, as in claim 21, including the additional step of using a manual switch, located in the wireless telephone base station, to switch the wireless telephone between a voice position in which the wireless telephone is used for voice communications, and a data position in which the wireless telephone is used for data transmission between a computer and a telephone land line.

24. A method, as in claim 13, including the additional step of using a portable computer to remotely switch the telephone from a voice position in which the wireless telephone is used for voice communications, and a data position in which the wireless telephone is used for data transmission between a computer and a telephone land line.
